(19) United States
(12) Patent Application Publication
(10) Pub. No.: US 2011/0151834 A1
(43) Pub. Date: Jun. 23, 2011

(54) Apparatus And Method For Determining An Invalid Base Station

(76) Inventors: Harsha Dabholkar, Libertyville, IL (US); James Snider, Kildeer, IL (US); Robert F. D'Avello, Lake Zurich, IL (US)

(21) Appl. No.: 12/643,463

(22) Filed: Dec. 21, 2009

(51) Int. Cl. H04W 12/12

(52) U.S. Cl. 455/410

(57) ABSTRACT

It is determined whether a base station is an invalid base station. At an electronic device at the vehicle, communications are wirelessly received from a base station. It is determined whether the base station is an invalid base station based at least in part upon at least one security parameter included in the received communications.

### CROSS REFERENCES TO RELATED APPLICATIONS

“Apparatus and Method of Detecting Jamming of Communications” having attorney docket number DP10050 (93738)

“Apparatus and Method for Broadcasting the Detection of RF Jammer Presence” having attorney docket number DP10051 (94690)

“Apparatus and Method for Compromised Vehicle Tracking” having attorney docket number DP10052 (94691)

“Apparatus and Method for Detecting a Cloned Base Station” having attorney docket number DP10053 (93740)

“Apparatus and Method for detecting Communication Interference” having attorney docket number DP10054 (93739)

“Apparatus and Method for Detecting a Cloned Base Station” having attorney docket number DP10055 (93741)

“Apparatus and Method for Determining Vehicle Location” having attorney docket number DP10057 (97059)

“Apparatus and Method for Maintaining Communication with a Stolen Vehicle Tracking Device” having attorney docket number DP10058 (97060)

“Apparatus and Method for Reducing False Alarms in Stolen Vehicle Tracking” having attorney docket number DP10059 (97061)

“Apparatus and Method for Tracking Stolen Vehicles” having attorney docket number DP10060 (97062)

“Apparatus and Method for Maintaining Communications with a Vehicle in the Presence of Jamming” having attorney docket number DP10061 (97102)

all of which are being filed on the same date as the present application and all of which having their contents incorporated herein by reference in their entireties.

### FIELD OF THE INVENTION

The field of the invention relates to communications between various entities and, more specifically to detect the jamming or attempted jamming of these communications.

### BACKGROUND

Vehicles are equipped with various types of communication systems that provide or facilitate various types of functions. For instance, a vehicle may be equipped with a global positioning satellite (GPS) system that provides for locating the vehicle and providing information concerning the location of the vehicle to a user. Vehicle security systems are also employed in many vehicles to protect the vehicle and its contents from theft or other criminal activity. For example, a vehicular security system may be configured to communicate with some outside entity (e.g., a police or security center) and when an attempt is made to break into a vehicle, the vehicular security system may transmit messages to the outside entity where appropriate action may be taken to prevent or stop the break in. Some jurisdictions even require the use of security systems in vehicles because of the high number of vehicle break-ins or thefts in these areas.

If a vehicle is stolen, stolen vehicle tracking (SVT) applications attempt to track and sometimes recover the stolen vehicle. To give one example, some SVT applications rely upon a GPS system to pinpoint the location of the vehicle and a Global System for Mobile communications (GSM) cellular network to report the incident to a service provider via Short Message Service (SMS) or General Packet Radio Service (GPRS) data connections.

Potential thieves have sometimes attempted to jam the receiver hardware located at the vehicle by employing devices that create a strong wide-band signal in the receive band and thereby block the GPS satellite from being received at the vehicle and/or to block GSM network signals that are sent from the cellular base station to the vehicle.

Additionally, a cellular jammer could emulate a base station (e.g., conduct a man-in-the-middle attack). More specifically, the jammer could then intercept the messages from devices at the vehicle and not relay them to the service provider. Thus, the devices could believe they are sending, for example, warning messages, to a valid base station when, in fact, these messages never reach the intended recipient.

### BRIEF DESCRIPTION OF THE DRAWINGS

FIG. 1 comprises a block diagram of a system that detects an invalid base station according to various embodiments of the present invention;

FIG. 2 comprises a block diagram of an apparatus that detects an invalid base station according to various embodiments of the present invention;

FIG. 3 comprises a flowchart of one example of an approach for detecting an invalid base station according to various embodiments of the present invention;

FIG. 4 comprises a call flow diagram of one example of an approach for detecting an invalid base station according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided where the validity of a base station is established by an electronic device at a vehicle so that the electronic device will not be fooled into transmitting signals to cloned or otherwise invalid base stations. The approaches described herein are easy to use, accurate in determining whether a base station is valid or invalid, and cost effective to implement resulting in enhanced security for vehicles and their contents.

Since the approaches described herein are implemented at an electronic device at the vehicle, they are not susceptible to tampering since the electronic device is typically secured within the vehicle. Additionally, the approaches not only determine the existence of an invalid base station but the likelihood of jamming of communications since the existence of an invalid base station likely indicates jamming (or attempted jamming). The determination of an invalid base station may also indicate potential theft of the vehicle in some circumstances. Consequently, remedial actions can be taken to circumvent the jamming or to alert authorized individuals or agencies.

As used herein, the term “invalid base station” refers to a base station or base station simulator that is not authorized to establish communications with electronic devices at a vehicle. In this respect, an invalid base station may be a “cloned” base station that simulates base station functions and is used by criminals or other unauthorized parties to spoof electronic devices at vehicles.

As used herein, “base station” refers to a device in a network that communicates with electronic devices in vehicles using any type of communication technology (e.g., any combination of hardware and software elements such as antennas, processors, and programmed software) or protocol. One example of a base station is a base station that is typically used in cellular communication networks. It will be appreciated, however, that as used herein “base station” is not limited to cellular base stations used in cellular networks and can include other elements such as routers, access points, and so forth.

In many of these embodiments, it is determined whether a base station is an invalid base station. At an electronic device at the vehicle, communications are wirelessly received from a base station. It is determined whether the base station is an invalid base station based at least in part upon at least one security parameter included in the received communications.

The security parameter can be a number of different parameters. For example, the security parameter may include a security certificate. In another example, the security parameter includes an encrypted random number. Other examples of security parameters may also be used.

In other aspects, when the base station is determined to be invalid, no information is communicated to the base station. Additionally, a warning may be sent to an authorized entity such as the police or a private security service. The determination that the base station is invalid may also indicate that jamming is occurring.

The determination as to whether the base station is valid or invalid may be made at various times. For example, the determination may be made during a registration period. In another example, the determination is made subsequent to a handover occurrence. The determination may be made periodically or randomly.

In others of these embodiments, an apparatus for determining whether a base station is an invalid base station includes an interface and a controller. The interface includes an input that is configured to wirelessly receive communications from a base station and an output. The controller is coupled to the interface and configured to determine whether the base station is an invalid base station based upon at least one security parameter of the received communication. In some examples, the at least one security parameter comprises a security certificate. In another example, the security parameter includes an encrypted random number. In some examples, the controller is further configured to not communicate any further information to the base station when it is determined that the base station is an invalid base station.

Validity of the base station can be established using any known encryption approach. As an example, an authentication procedure exchanges messages between an electronic device in a vehicle and a base station to determine the cipher suite to be used to exchange messages. The base station has an associated certificate and then sends this certificate to the electronic device in the vehicle. The client (i.e., the electronic device at the vehicle) then performs authentication of the certificate using a public key algorithm as is known in the art.

In another example, a challenge/response approach may be used to establish base station validity. In this approach, the base station does not send the shared secret to prove validity. Instead, the electronic device at the vehicle challenges the base station to correctly encrypt a previously unused random number with their shared secret key. Only the shared secret key will correctly encrypt the random number. The electronic device compares the encrypted result to an expected result, and if a match exists then validity of the base station is established. If no match is established, then the base station is determined to be invalid.

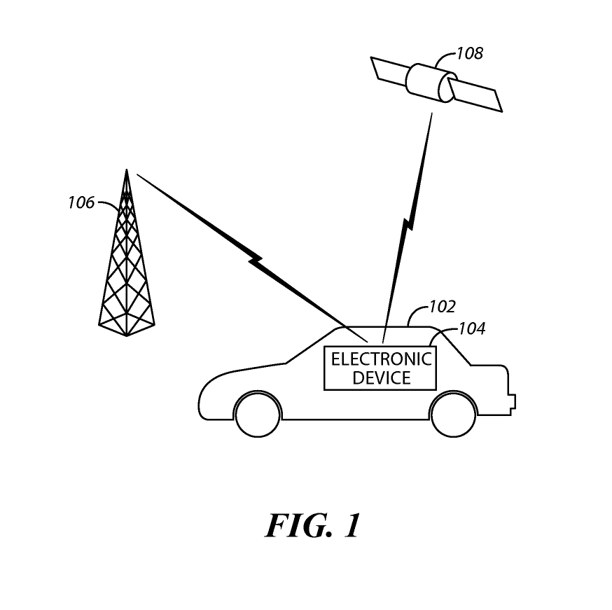

Referring now to FIG. 1, one example of a system for determining whether a base station is valid is described. A vehicle 102 includes an electronic communication device 104. The device 104 is disposed anywhere in or at the vehicle and communicates with a base station 106 and an external navigation system 108.

The electronic device 104 may be, in one example, a programmed electronic device that determines the location of the vehicle 102 from signals received from the navigation system 108 and determines if jamming and/or attempted jamming is occurring as to signals being received and/or being transmitted. Alternatively, another separate device may be used to determine the location of the vehicle and this separate device may communicate with the communication and jamming detection device 104. The external navigation system 108 may be a GPS satellite or satellite system, in one example.

In other examples, the device 104 may be a portable electronic device such as a cellular phone, pager, personal digital assistant, or personal computer. In still other examples, the device 104 may implement stolen vehicle tracking (SVT) functions or provide SVT assistance. Any or all of the above-mentioned functions (e.g., jamming detection, cellular phone functions, pager functions, computer functions, personal digital assistant functions, location determination functions, or SVT functions) may be incorporated into the device 104.

The device 104 communicates with a base station 106. In one example, the base station 106 is a cellular base station as used in a cellular network. The base station 106 is any combination of electronic hardware and software that allows these communications to be conducted. It will be appreciated, however, that the base station 106 is not limited to cellular base stations used in cellular networks and/or can include other elements such as routers, access points, and so forth.

Many of the approaches described herein are described as being executed by devices that are at least partially disposed at or within a vehicle. However, it will be appreciated that the approaches described herein are not limited to devices that can be disposed at or within vehicles, but can be used with devices that are disposed at any location such as within homes, businesses, or even with individuals that are not within or associated with a vehicle.

The vehicle 102 may be any type of vehicle such as a car, truck, bus, airplane, ship, to name a few examples. The communication device 104 is any type of communication device that communicates with entities outside the vehicle 102 using any type of communication technology or protocol. For example, the communication device 104 may be or may incorporate a cellular phone, transponder, radio, or some combination of these or other devices.

In one example of the operation of the system of FIG. 1, it is determined whether a base station is an invalid base station. At the electronic device 104 at the vehicle 102, communications are wirelessly received from the base station 106. It is determined whether the base station 106 is an invalid base station based at least in part upon at least one security parameter included in these received communications.

The security parameter can be a number of different parameters. For example, the security parameter may include a security certificate. In another example, the security parameter includes an encrypted random number. Other examples of security parameters may also be used.

In other aspects, when the base station 106 is determined to be invalid, no further information is communicated to the base station 106. Additionally, a warning may be sent to an authorized entity such as the police or a private security service. The determination that the base station 106 is invalid may also indicate that jamming is occurring.

The determination as to whether the base station 106 is valid or invalid may be made at various times. For example, the determination is made during a registration period. In another example, the determination is made subsequent to a handover occurrence. The determination may be made periodically or randomly.

Validity of the base station 106 can be established using any known encryption/security approach or procedure. As an example, an authentication procedures exchanges messages between the electronic device 104 in the vehicle 102 and a base station 106 to determine the cipher suite to be used. The base station 106 then sends its certificate to the electronic unit 104 in the vehicle 102. The client (i.e., the electronic device 104) then performs authentication using a public key algorithm as is known in the art.

In another example, a challenge/response approach may be used to establish base station validity. In this approach, the base station 106 does not send the shared secret to prove validity. Instead, the electronic device 104 at the vehicle 102 challenges the base station 106 to correctly encrypt a previously unused random number with their shared secret key. Only the shared secret key will correctly encrypt the random number. The electronic device 104 compares the encrypted result to an expected result, and if a match exists then validity of the base station 106 is established. If no match is established, then the base station 106 is determined to be invalid.

Any number of antennas may be used by the device 104. In one example two antennas are used and one antenna is used to transmit signals and the other is used to receive signals. In other examples, multiple TX and RX antennas can be used with some of the antennas being used as backup antennas. If the path loss abruptly changes, then the device can switch antennas. In one aspect, when jamming is occurring (or detected to be occurring) then the device can switch antennas and attempt to communicate on the backup antenna or backup antennas. In still other examples, a single antenna is used.

In another aspect, once an invalid base station is detected (and jamming is inferred from this detection) various actions can be taken that affect the operation of the vehicle 102 and/or a driver's ability to successfully drive the vehicle 102. In these examples, it is assumed that the detection of jamming denotes an attempt to steal by a criminal to steal the vehicle 102 and/or its contents. Consequently, these approaches attempt to stop the theft of the vehicle 102 and/or its contents by adversely affecting the operation of the vehicle so that the criminal has a difficult or impossible time operating the vehicle 102. For example, the radio operation can be changed (e.g., by setting its sound level to a deafening level), the operation of the lights of the vehicle can be adjusted (e.g., by deactivating the lights at night), the operation of the horn can be altered (e.g., by activating the horn), the operation of the stability control system can be altered (e.g., to cause unstable operation), the seat location can be adjusted (e.g., by moving the seat to an uncomfortable position), the operation of heat controlled seats can be changed (e.g., by setting a temperature that is uncomfortable or scalding to a driver), the steering wheel operation can be altered (e.g., by locking the steering wheel), the temperature of the vehicle interior can be changed (e.g., by setting the temperature to an uncomfortable hot or cold setting), and/or the tone of an audible device can be altered (e.g., to produce a deafening tone) based upon the detection of jamming to thereby make theft of the vehicle and/or its contents difficult or impossible for the thief to achieve.

In addition, once an invalid base station is determined, further actions can be performed to confirm that jamming is occurring. For example, as described in co-pending application entitled “Apparatus and Method for Detecting Jamming of Communications” filed on the same date as the present application and having attorney docket number DP10050, a signal strength indicator is a numeric value that generally indicates the strength of a received signal in cellular communication systems. More specifically, the signal strength indicator is a value that indicates the magnitude of the signals that are transmitted and received within these systems.

A first rate of rise of a signal strength indicator associated with the first communication channel and a second rate of rise of a signal quality indicator associated with the first communication channel are monitored. The signal strength indicator may be a received signal strength indicator (e.g., Rx Level) and the signal quality indicators may be the RX quality level (e.g., Rx Qual). When at least one of the first rate rises at a rate greater than a first predetermined threshold rate and the second rate rises at a rate greater than a second predetermined threshold rate, jamming can be determined to exist. Consequently, using this or other jamming detection approaches, the existence of jamming can be confirmed or verified.

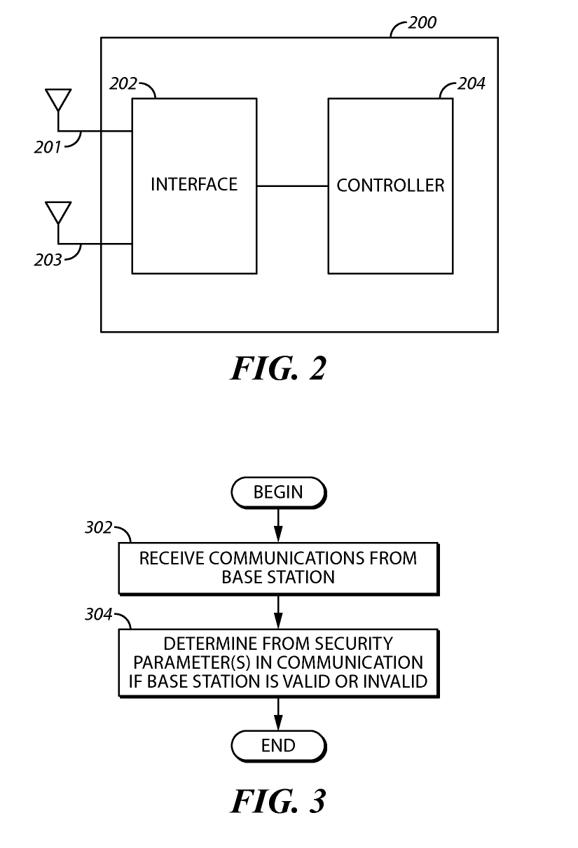

Referring now to FIG. 2, an apparatus 200 for determining whether a base station is an invalid base station includes an interface 202 and a controller 204. The interface 202 includes an input 201 that is configured to wirelessly receive communications from a base station and an output 203.

The controller 204 is coupled to the interface 202 and configured to determine whether the base station is an invalid base station based upon at least one security parameter of the received communication. In some examples, the security parameter comprises a security certificate. In another example, the security parameter is associated with an encrypted random number. Other examples of security parameters are possible.

In some examples, the controller 204 is further configured to not communicate any information to the base station at the output 203 of the interface 202 when it is determined that the base station is an invalid base station. In still other examples, various approaches can be used to warn an appropriate authority (e.g., the police or a private security service provider) that an invalid base station has been detected.

Referring now to FIG. 3, one example of an approach for determining the validity of a base station is described. At step 302 and at an electronic device at the vehicle, communications are wirelessly received from a base station. The communications may include one or more security parameters that are used by the electronic device at the vehicle to determine whether the base station is valid or invalid. In this respect, the security parameter may be an encrypted random number or a security certificate. Other examples of security parameters are possible.

At step 304, it is determined whether the base station is an invalid base station based at least in part upon at least one security parameter included in the received communications. For example, if an encrypted random number is received, the electronic device may compare the encrypted random number (that has been encrypted at the base station) to the expected value of the random number (that has been encrypted at the electronic device). If a match is found, then the base station is determined to be valid. If a match is not found, then the base station is determined to be invalid. It will be appreciated that the approach using random numbers is one example of an approach that can be used to determine the authenticity of a base station from an electronic device in a vehicle and that other approaches may also be used. For example, Internet Key Exchange, IPsec, Kerberos, Transport Layer Security (TLS), Challenge Handshake Authentication Protocol (CHAP), Extensible Authentication Protocol (EAP) may be used.

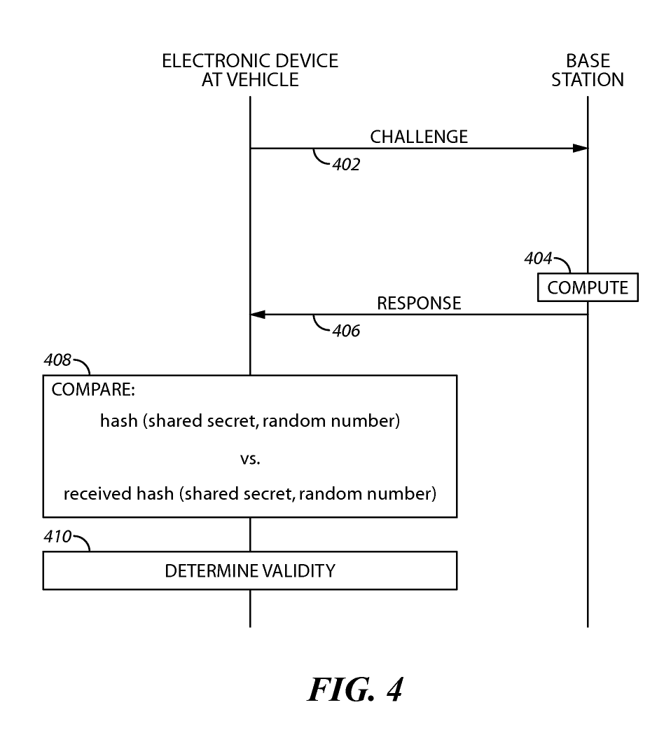

Referring now to FIG. 4, one example of a validation approach is described. At step 402, a challenge is issued from an electronic device at the vehicle. The challenge includes a random number and is transmitted to the base station.

At step 404, the base station uses a shared secret (e.g., secret key) to encrypt the random number. The encrypted message may be created using a hash function. At step 406, this response is sent back to the electronic unit at the vehicle. At step 408 and at the electronic device at the vehicle, a comparison is made as between the received result and the expected result (i.e., by using a hash function at the electronic device to determine the expected result).

At step 410, a determination as to validity of the base station is made based upon the comparison. If a match occurs as a result of the comparison, then the base station is determined to be valid and communications with the base station can proceed. On the other hand, if no match is obtained in the comparison, then the base station is invalid and steps can be taken to issue a warning to appropriate authorities such as the police or a private security provider. Additionally, no further communications may be conducted with the base station. It will be appreciated that the approach using random numbers is one example of an approach that can be used to determine the authenticity of a base station from an electronic device in a vehicle and that other approaches may also be used.

Thus, approaches are provided where the validity of a base station is established by an electronic device at a vehicle so that the electronic devices will not be fooled into transmitting signals to cloned or otherwise invalid base stations. The approaches described herein are easy to use, accurate in determining whether a base station is valid or invalid, and cost effective to implement resulting in enhanced security for vehicles and their contents.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of determining whether a base station is an invalid base station, the method comprising:
at an electronic device at the vehicle:
wirelessly receiving communications from a base station;
determining whether the base station is an invalid base station based at least in part upon at least one security parameter included in the received communications.

2. The method of claim 1 wherein the at least one security parameter comprises a security certificate.

3. The method of claim 1 wherein the at least one security parameter comprises an encrypted random number.

4. The method of claim 1 further comprising discontinuing communication of information to the base station upon determining that the base station is an invalid base station.

5. The method of claim 1 wherein the determination is made during a registration period.

6. The method of claim 1 wherein the determining is made subsequent to a handover occurrence.

7. The method of claim 1 wherein the determining is made periodically.

8. The method of claim 1 further comprising transmitting an alarm message to an outside entity upon determining that the base station is determined to be invalid.

9. The method of claim 8 wherein the outside entity is selected from the group consisting of: a police agency and a private security provider.

10. An apparatus configured to determine whether a base station is an invalid base station, the method comprising:
an interface, the interface having an input that is configured to wirelessly receive communications from a base station and an output;
a controller coupled to the interface, the controller configured to determine whether the base station is an invalid base station based upon at least one security parameter of the received communication.

11. The apparatus of claim 10 wherein the at least one security parameter comprises a security certificate.

12. The apparatus of claim 10 wherein the at least one security parameter comprises an encrypted random number.

13. The apparatus of claim 10 wherein the controller is further configured to discontinue communication of information to the base station upon determining that the base station is an invalid base station.

14. The apparatus of claim 10 wherein the determination by the controller is made during a registration period.

15. The apparatus of claim 10 wherein the determination by the controller is made subsequent to a handover occurrence.

16. The apparatus of claim 10 wherein the determination by the controller is made periodically.

17. The apparatus of claim 10 wherein the controller is further configured to transmit an alarm message at the output of the interface to an outside entity when the base station is determined to be invalid.

18. The apparatus of claim 17 wherein the outside entity is selected from the group consisting of: a police agency and a private security provider.

19. A computer usable medium having a computer readable program code embodied therein, said computer readable program code adapted to be executed to implement a method of determining whether a base station is an invalid base station, the method comprising:
at an electronic device at the vehicle:
wirelessly receiving communications from a base station;
determining whether the base station is an invalid base station based at least in part upon at least one security parameter included in the received communications.

20. The computer usable medium of claim 19 wherein the at least one security parameter comprises a security certificate.
